(19) United States
(12) Patent Application Publication
(10) Pub. No.: US 2025/0139507 A1
(43) Pub. Date: May 1, 2025

(54) ELECTRICAL APPLIANCE STATUS ANALYSIS DEVICE AND METHOD

(71) Applicant: INSTITUTE FOR INFORMATION INDUSTRY, TAIPEI CITY (TW)

(72) Inventors: Kuang-Ping TSENG, TAIPEI CITY (TW); Wen-Jen HO, TAIPEI CITY (TW); Yung-Chieh HUNG, TAIPEI CITY (TW); Kuei-Chun CHIANG, TAIPEI CITY (TW)

(73) Assignee: INSTITUTE FOR INFORMATION INDUSTRY, TAIPEI CITY (TW)

(21) Appl. No.: 18/517,987

(22) Filed: Nov. 22, 2023

(30) Foreign Application Priority Data
Oct. 30, 2023 (TW) 112141594

(51) Int. Cl. G06N 20/00

(52) U.S. Cl. CPC G06N 20/00

(57) ABSTRACT

An electrical appliance status analysis device and method are provided. Based on the correlation between appliance status sequence data and electricity meter sequence data, appliances are categorized into high-correlation appliances and low-correlation appliances. For high-correlation appliances, training is conducted using the first-type model directly based on the appliance status sequence data and electricity meter sequence data. For low-correlation appliances, features are extracted to produce appliance status feature data and electricity meter feature data, which are then combined with user information feature data to train a second-type model. This method remains applicable at low sampling frequencies. Even when the data sampling rate is below 1 Hz, the resulting appliance status analysis models provide accurate analysis results, addressing the limitations of NILM technology in analyzing data with low sampling frequency.

### CROSS-REFERENCE TO RELATED APPLICATIONS

This application claims the priority benefit of TW application serial No. 112141594, filed on Oct. 30, 2023. The entirety of the above-mentioned patent application is hereby incorporated by reference herein and made a part of the specification.

### BACKGROUND OF THE INVENTION

### 1. Field of the Invention

The present invention relates to an analysis device and method, and more particularly to an electrical appliance status analysis device and method.

### 2. Description of the Related Art

As the demand for energy continues to rise, along with the development of energy technology to increase supply, conserving energy and reducing consumption are also critical to improve energy usage efficiency. To minimize unnecessary energy usage and allocate electrical power with high efficiency, a recent international trend in energy conservation involves using cloud platforms and behavioral science combined with big data analytics for electricity to conduct electricity usage behavior analysis for household consumers or other electricity-using entities. Based on the analysis results, personalized improvement suggestions are provided to encourage consumers to modify their electricity usage habits, in order to achieve energy-saving goals.

In recent years, many advanced countries have been actively developing Non-Intrusive Load Monitoring (NILM) technology. NILM focuses on determining the real-time load status of different appliances of a user based on the total electrical load information from the electric meter that connects to the appliances. For instance, the load status could refer to the on and off states of each appliance. In other words, without the need to install power monitor device on every appliance of the user, NILM reduces equipment and installation costs and increases ease of use, thus enhancing user acceptance.

During the training phase of the machine learning model of existing NILM technology, the total electrical load information of each user and the appliance load information from monitor devices connected to appliances of the user are used to train the analysis model for each appliance. Usually, training data for the total electrical load and appliance load information is obtained in a setup laboratory environment with a sampling rate of, for example, 1000 Hz. The same machine learning model architecture is used for different types of appliances during training to obtain analysis models for different types of appliances.

However, when the trained analysis models are applied in real-world settings, obtaining the total electrical load information of the user requires transmission over a wireless network. For a typical household, the wireless network transceiver is often far from the electric meter monitor device or the appliance monitor devices, with obstructions often blocking the signal, making the transmission efficiency or quality very unstable. It has been proven difficult to achieve even tens of hertz in sampling frequency, let alone the hundreds of thousands of hertz required for total electrical load information. With such low sampling frequencies, it is difficult for the analysis model of NILM to obtain accurate and effective analysis results, and even more difficult to develop corresponding energy service strategies accordingly.

In summary, the current NILM technologies still need further improvements.

### SUMMARY OF THE INVENTION

Since it is challenging for existing NILM technologies to obtain precise and efficient analysis result in a real-world environment with electricity usage information having low sampling rates, the present invention provides an electrical appliance status analysis device.

The electrical appliance status analysis device of the present invention, electrically connected to an electricity meter, includes a storage unit and a processor. The storage unit is configured to store plurality of user information feature data, plurality of electricity meter sequence data, and plurality of appliance status sequence data, wherein each appliance status sequence data corresponds to a respective appliance type, and has the same time series as the corresponding electricity meter sequence data. The processor is electrically connected to the storage unit, configured to read the plurality of user information feature data, the plurality of electricity meter sequence data, and the plurality of appliance status sequence data, and configured to perform the following steps to the appliance status sequence data corresponding to the same appliance type: defining said appliance type as a high-correlation appliance or a low-correlation appliance according to an average correlation coefficient of the plurality of appliance status sequence data and corresponding electricity meter sequence data; inputting the electricity meter sequence data and the plurality of appliance status sequence data defined as high-correlation appliance into a first-type model to perform model training, and generating a first-type appliance status analysis model for said appliance type; performing a feature extraction process on the appliance status sequence data and the electricity meter sequence data defined as low-correlation appliance, generating a plurality of appliance feature data and a plurality of electricity meter feature data; and inputting the plurality of appliance feature data and the plurality of electricity meter feature data into a second-type model to perform model training, and generating a second-type appliance status analysis model for said appliance type; and inputting an unanalyzed electricity meter sequence data into the first-type appliance status analysis model, or inputting an unanalyzed electricity meter feature data and an unanalyzed user information feature data into the second-type appliance status analysis model, and generating at least one appliance status analysis result corresponding to at least one of the appliance types.

The present invention further provides an electrical appliance status analysis method, executed based on plurality of user information feature data, plurality of electricity meter sequence data, and plurality of appliance status sequence data, wherein each appliance status sequence data corresponds to a respective appliance type, and has the same time series as the corresponding electricity meter sequence data. The analysis method includes the following steps: reading the plurality of user information feature data, the plurality of electricity meter sequence data, and the plurality of appliance status sequence data, and performing the following steps to the appliance status sequence data corresponding to the same appliance type; defining said appliance type as a high-correlation appliance or a low-correlation appliance according to an average correlation coefficient of the plurality of appliance status sequence data and corresponding electricity meter sequence data; inputting the plurality of electricity meter sequence data and the plurality of appliance status sequence data defined as high-correlation appliance into a first-type model to perform model training, and generating a first-type appliance status analysis model for said appliance type; performing a feature extraction process on the plurality of appliance status sequence data and the plurality of electricity meter sequence data defined as low-correlation appliance, generating a plurality of appliance feature data and a plurality of electricity meter feature data; and inputting the plurality of appliance feature data, the plurality of electricity meter feature data, and the plurality of user information feature data into a second-type model to perform model training, and generating a second-type appliance status analysis model for said appliance type; and inputting an unanalyzed electricity meter sequence data into the first-type appliance status analysis model, or inputting an unanalyzed electricity meter feature data and an unanalyzed user information feature data into the second-type appliance status analysis model, and generating at least one appliance status analysis result corresponding to at least one of the appliance types.

The electrical appliance status analysis device and method of the present invention primarily categorize appliance types into high-correlation and low-correlation appliances based on the average correlation coefficient between the plurality of appliance status sequence data and corresponding electricity meter sequence data. For the high-correlation appliance types, the appliance status sequence data and corresponding electricity meter sequence data are directly input into first-type model for training to generate a first-type appliance status analysis model corresponding to the appliance type defined as high-correlation appliance type. For the low-correlation appliance types, the appliance status sequence data and the corresponding electricity meter sequence data undergo a feature extraction process to produce appliance status feature data and electricity meter feature data. The appliance status feature data and electricity meter feature data along with user information feature data are inputted into second-type model for training to produce a second-type appliance status analysis model corresponding to the appliance type defined as low-correlation appliance types. When the unanalyzed electricity meter sequence data to be analyzed is inputted into the corresponding first-type or second-type appliance status analysis model for different appliances, the appliance status analysis results for the different appliances are obtained.

In short, the present invention classifies the appliances into high-correlation and low-correlation appliances, and chooses different data preprocessing methods and machine learning models accordingly. Therefore, appliance status analysis models for appliances of different correlations are generated, improving the accuracy of appliance status analysis results and the applicability at low sampling frequencies. According to experimental results, the invention is applicable at low data sampling frequencies. Even when the sampling frequency of the electricity meter sequence data and the appliance status sequence data is below 1 Hz, the present invention can provide accurate and effective analysis results during the analysis phase of the unanalyzed electricity meter sequence data. The present invention resolves the difficulty of effective analysis with existing Non-Intrusive Load Monitoring (NILM) technology when high-frequency data to be analyzed is not available.

Other objectives, advantages and novel features of the invention will become more apparent from the following detailed description when taken in conjunction with the accompanying drawings.

### BRIEF DESCRIPTION OF THE DRAWINGS

FIG. 1 is a block diagram of the system of the electrical appliance status analysis device of the present invention.

FIG. 2 is a block diagram of the application environment of the electrical appliance status analysis device of the present invention.

FIG. 3 shows waveform charts of the appliance status sequence data and the appliance electricity usage original data in the electrical appliance status analysis device of the present invention.

FIG. 4 is a flowchart of the steps in the electrical appliance status analysis method of the present invention.

FIG. 5 is a detailed flowchart of step S102 of the electrical appliance status analysis method of the present invention.

FIG. 6 shows waveform charts of the electricity meter status sequence data and the denoised electricity meter status sequence data in the electrical appliance status analysis device of the present invention.

### DETAILED DESCRIPTION OF THE INVENTION

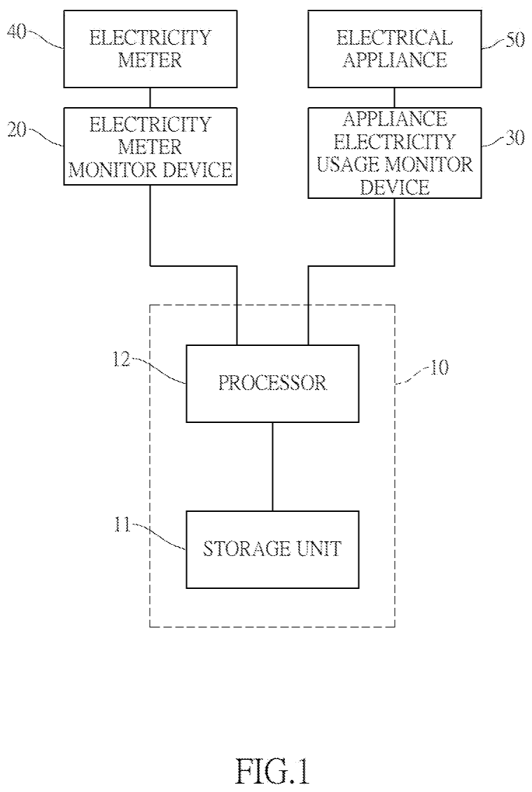

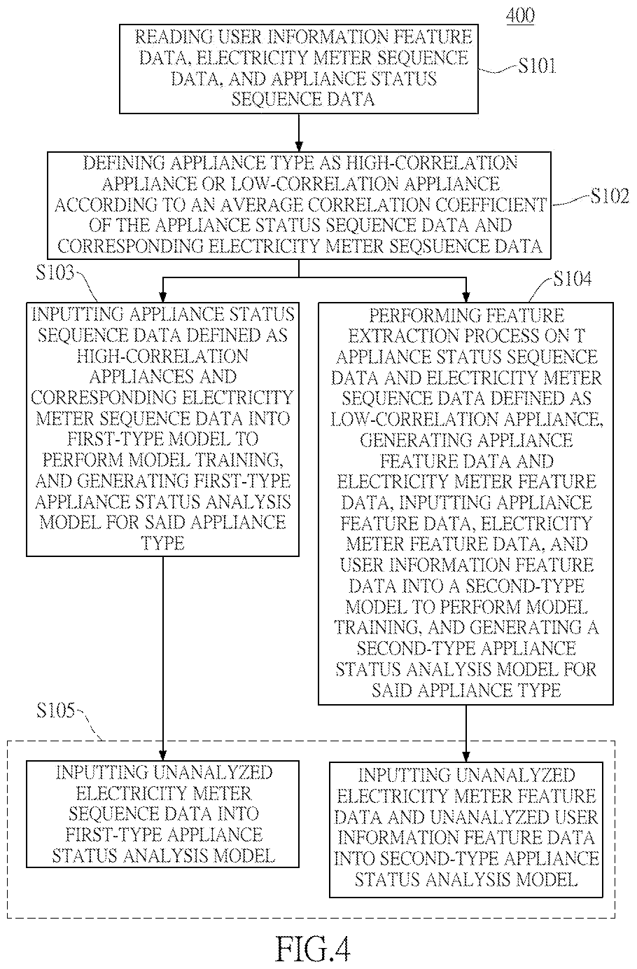

With reference to FIG. 1, the electrical appliance status analysis device 10 mainly includes a storage unit 11 and a processor 12, and the electrical appliance status analysis device 10 is electrically connected to at least one electricity meter monitor device 20 and at least one appliance electricity usage monitor device 30. The electricity meter monitor device 20 is electrically connected to an electricity meter 40, and the appliance electricity usage monitor device 30 is electrically connected to an electrical appliance 50. The storage unit 11 stores a plurality of user information feature data, a plurality of electricity meter sequence data, and a plurality of electrical appliance status sequence data that belong to different users. The processor 12 is electrically connected to the storage unit 11 to read the user information feature data, the electricity meter sequence data, and the appliance status sequence data, and is configured to perform the electrical appliance status analysis method 400 as shown in FIG. 4. The “electrical appliance” will be referred to as “appliance” in the following description for simplicity.

The meaning of each information stated above will be elaborated first herein.

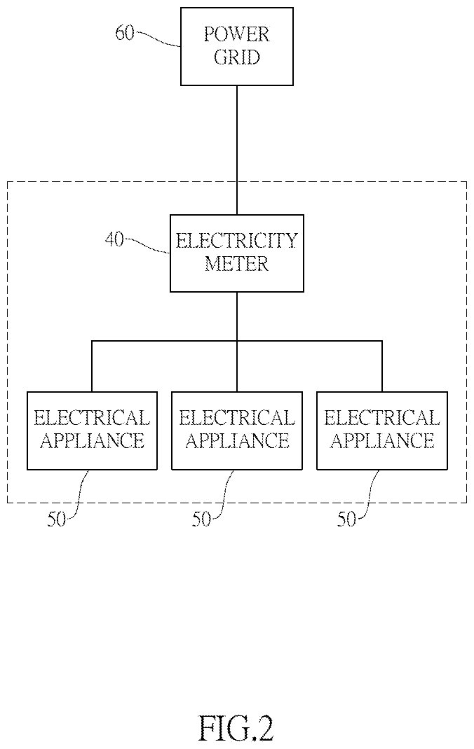

With reference to FIG. 2, in an embodiment, the data sampling environment includes that each user has an electricity meter 40 and a plurality of appliances of different appliance types. Each appliance 50 is connected to the power grid 60 through the electricity meter 40, and therefore the load of the appliances 50 passes through the electricity meter 40, and affects the curve shape of the electricity meter 40. In other words, the total electrical load presented in the electricity meter sequence data is the sum of the electrical load of all appliances 50.

The electricity meter monitor device 20 is electrically connected to the electricity meter 40 to receive total load meter information. The appliance electricity usage monitor device 30 is electrically connected to the appliance 50 to measure the real-time load of the appliances, and transmits the monitored information to the appliance status analysis device 10. Therefore, the appliance status sequence data produced from each appliance 50 corresponds to an appliance type, and corresponds to the electricity meter sequence data of the same user, and has a same time series as the electricity meter sequence data. The appliance types, for example, may be refrigerator, washing machine, television, or air conditioner, etc. Namely, the appliance type is predefined according to the originating appliance of the appliance status sequence data.

The appliance status sequence data contains a plurality of data points with temporal dependencies, each corresponding to either an on-state tag or an off-state tag. For example, the appliance status sequence data may be generated based on the appliance electricity usage original data output from the plurality of appliance electricity usage monitor devices 30 connected to the user's appliances. The disclosed appliance status analysis device 10 connects to the appliance electricity usage monitor devices 30 of each user to receive the appliance electricity usage original data. The processor 12 performs data preprocessing and status tagging procedures on the appliance electricity usage original data to generate the appliance status sequence data. In more detail, the status tagging procedure includes dividing the time series of the appliance electricity usage original data by the tagging cycle, comparing the data points in each tagging cycle with the activated load threshold value, and calculating the number of data points in the tagging cycle that exceed the activated load threshold value. If the number of data points that exceed the activated load threshold value within the tagging cycle is higher than a comparing number threshold value, then the plurality of data points in the tagging cycle correspond to the on-state tag. If the number of data points that exceed the activated load threshold value within the tagging cycle is lower than the comparing number threshold value, the plurality of data points in the tagging cycle correspond to the off-state tag. In other words, each data point of the appliance status sequence data represents whether the appliance usage status in that tagging cycle is on or off.

For instance, the sampling frequency of the appliance electricity usage original data is 1/60 Hz, which means one data point per minute; the tagging cycle is 5 minutes, with a comparing number threshold value of 2. Therefore, the processor 12 calculates the number of data points in the appliance electricity usage original data that exceed the activated load threshold value per 5 minutes. If the count of data points that exceed the activated load threshold value is more than 2, which is over half, then all the data points within that tagging cycle are tagged as with the on-state tag. Conversely, if the count is not more than 2, meaning less than half, then all the data points within that tagging cycle are tagged with the off-state tag. This process thus obtains appliance status sequence data for every 5-minute cycle.

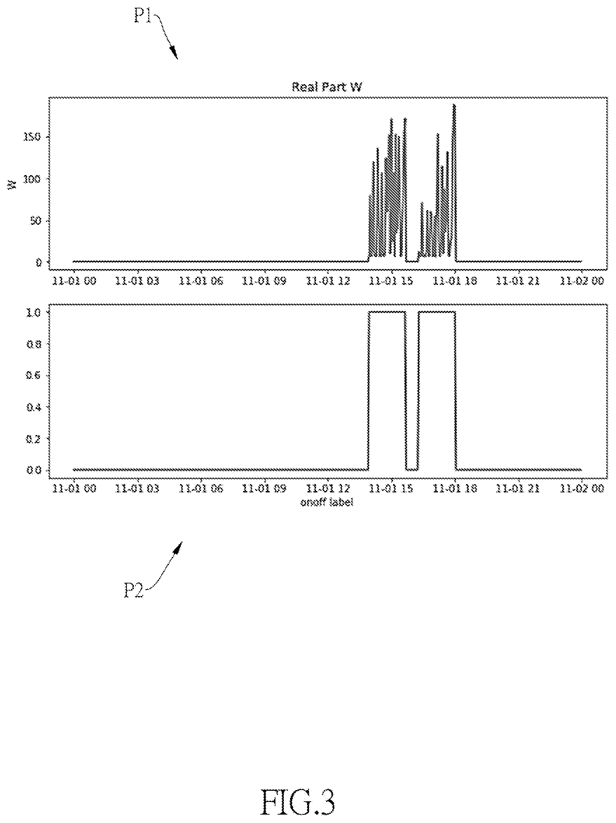

With reference to FIG. 3, where the waveform chart of the upper part is an exemplary appliance electricity usage original data waveform chart P1, with the y-axis representing the electricity load value in watts (W). The lower part is the appliance usage status waveform chart P2, drawn according to the data points of each appliance status sequence data after the status tagging procedure, with the y-axis representing the on-state or off-state tags expressed numerically, wherein “0” indicates off-state tag, and “1” indicates on-state tag. The x-axis for both represents a time series with 3-hour intervals. From the comparison of the two, it can be understood that the value of the appliance electricity usage original data is OW, the appliance status sequence data is 0 (off-state tag). Then, the value of the appliance electricity usage original data is significantly higher than OW, the appliance status sequence data is 1 (on-state tag).

Different activated load threshold values can be set according to different appliance types. For example, activated load threshold value can be set based on a rated activating power value of the appliance type.

The electricity meter sequence data is collected and processed by an electricity meter monitor device 20 connected to the user's electricity meter 40, which includes the plurality of total load original data with temporal dependency. For example, the disclosed appliance status analysis device 10 is connected to the electricity meter monitor devices 20 of each user to receive the users' electricity meter original data. The processor 12 performs a data preprocessing procedure on the electricity meter original data to generate electricity meter sequence data. The data preprocessing procedure may include steps such as missing value imputation, data resampling, or data alignment. Data resampling refers to resampling the original electricity meter data according to a preset sampling frequency, thereby generating electricity meter sequence data that conforms to the preset sampling frequency.

User information feature data is used to reflect user characteristics, which may include user routine survey information, user appliance usage habit survey information, user household member survey information, and user electricity meter load classification label information, or any other information that is not directly derived from electricity sampling data and is related to the user's electricity usage characteristics. For example, user information feature data May be obtained initially through questionnaire surveys and then further digitized into computer-readable feature data. User electricity meter load classification label information may be a user electricity meter load classification tag assigned in advance through a user electricity meter classification model, based on the user's electricity meter data over a certain period, reflecting that the user's electricity meter load pattern is similar to a particular type of electricity load pattern type.

With reference to FIG. 4, the appliance status analysis method 400 of the present disclosure is executed by the processor 12, including steps S101-S101. Each step will be elaborated further below.

In step S101, the processor 12 reads the user information feature data, the electricity meter sequence data, and the appliance status sequence data, and respectively performs the following steps to the appliance status sequence data corresponding to the same appliance type.

In step S102, the processor 12 defines the appliance type as a high-correlation appliance or a low-correlation appliance according to an average correlation coefficient of the appliance status sequence data and corresponding electricity meter sequence data.

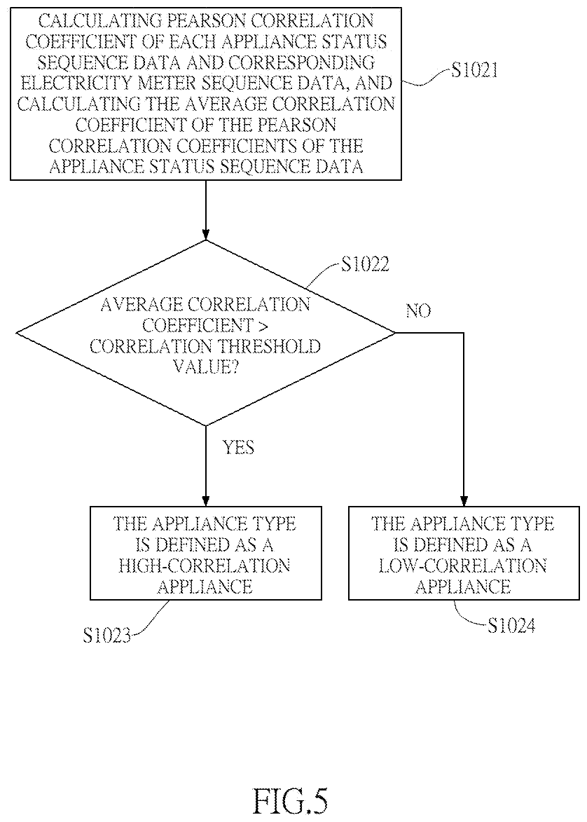

With reference to FIG. 5, step S102 further includes sub-steps S1021-S1024. To the appliance status sequence data corresponding to the same appliance type, the processor 12 first calculates the Pearson Product-Moment Correlation Coefficient for each appliance status sequence data and its corresponding electricity meter sequence data, and then calculates the average correlation coefficient of these Pearson correlation coefficients (step S1021). In other words, the processor 12 calculates the average value of the Pearson correlation coefficients for the appliance status sequence data corresponding to the same appliance type as the average correlation coefficient.

Next, the processor 12 compares the average correlation coefficient with a correlation threshold value (step S1022). If the average correlation coefficient is higher than the correlation threshold value, the appliance type corresponding to such appliance status sequence data is defined as high-correlation appliance (step S1023). If the average correlation coefficient is lower (not higher) than the correlation threshold value, the appliance type corresponding to such appliance status sequence data is defined as low-correlation appliance (step S1024). Preferably, the correlation threshold value is, for example, 0.4.

The average correlation coefficient represents the correlation between the appliance usage status and the load of the electricity meter 40. The correlation referred to in this disclosure relates to the association between the appliance usage status of each appliance type and the load curve trend or the electricity meter sequence data of the electricity meter 40. Generally, appliances with a high electricity load per unit time or those frequently turned on for long periods have a greater impact on the trend of the load curve of the electricity meter, therefore having higher correlation, such as air conditioners and refrigerators. Conversely, appliances with a lower electricity load per unit time or typically turned on for shorter durations have a lower correlation, such as televisions and washing machines.

In step S103, the processor 12 inputs the appliance status sequence data defined as high-correlation appliance along with the corresponding electricity meter sequence data into a first-type model for training, and generates a first-type appliance status analysis model for the appliance type.

In step S104, the processor 12 performs a feature extraction process on the appliance status sequence data defined as low-correlation appliance and the corresponding electricity meter sequence data to generate the plurality of appliance feature data and the plurality of electricity meter feature data. Then, the processor 12 inputs the appliance feature data, electricity meter feature data, and user information feature data into a second-type model for training, and generates a second-type appliance status analysis model for the appliance type.

In the present disclosure, the second-type model is different from the first-type model. Preferably, the first-type model is a neural network deep learning model, while the second-type model is a machine learning model that is different from the first-type model. More specifically, the second-type model may be, for example, a gradient boosting machine that is not a neural network deep learning model, a decision tree classification model, or a support vector machine model.

In the present disclosure, appropriate machine learning and training data techniques are selected for training the appliance status analysis model for specific appliance types according to the correlation between different appliance types and electricity meter loads.

For high-correlation appliances, the model training adopted is based on raw data. As can be understood from step S103, the processor 12 inputs the time-axis based appliance status sequence data and electricity meter sequence data directly into the first-type model, thereby generating the first-type appliance status analysis model. In an embodiment, the first-type model includes a Convolutional Neural Network Denoising Auto-encoder deep learning model.

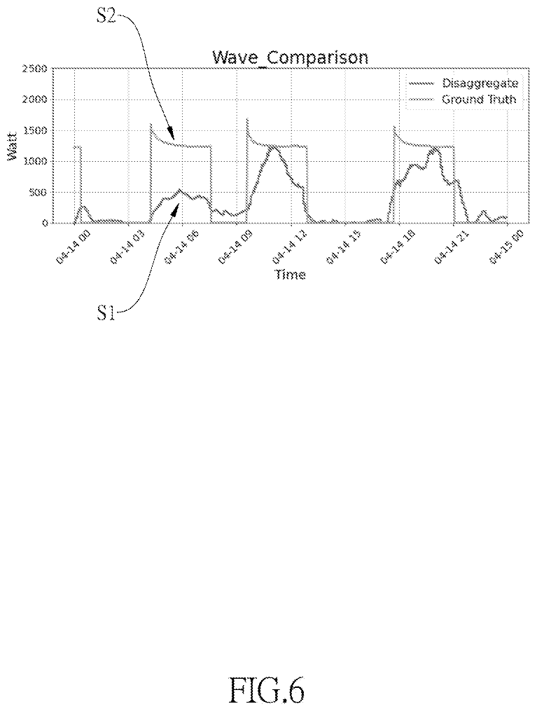

Such approach is based on the premise that high-correlation appliances significantly impact the waveform of the electricity meter sequence data due to the strong association between the appliance status sequence data and the electricity meter sequence data. Therefore, the appliance status sequence data of high-correlation appliances are considered as the main waveform components affecting the electricity meter sequence data, while other components in the electricity meter sequence data (such as waveform changes caused by the turning on or off of low-correlation appliances) are treated as noise. The first-type model removes the noise components from the electricity meter status sequence data based on the appliance status sequence data, obtaining the denoised electricity meter status sequence data. Please also refer to FIG. 6, which shows an exemplary original electricity meter status sequence data waveform S1 and the denoised electricity meter status sequence data waveform S2 after processing by the first-type model of this embodiment. From the figure, it is evident that the original electricity meter status sequence data waveform S1 contains irregular shapes, while the denoised electricity meter status sequence data waveform S2 more directly reflects the changes in electricity load caused by the on and off states of high-correlation appliances.

For low-correlation appliances, feature-based model training is adopted. As known from step S104, the processor 12 first performs a feature extraction process on the appliance status sequence data and the electricity meter sequence data to obtain feature data, and then conducts model training for the second-type model based on the generated feature data. The appliance status feature data and electricity meter feature data may include at least one or a combination of the following: the mean, standard deviation, minimum, maximum, 5% percentile, 95% percentile, average amplitude, peak-to-peak error, crest factor, skewness, kurtosis, shape factor, and impulse factor of the appliance status sequence data and electricity meter sequence data.

Moreover, it should be noted that, when training the second-type model, user information is also incorporated as part of the feature data along with the appliance status feature data and electricity meter feature data. This is based on the low correlation between the status of low-correlation appliances and the electricity meter sequence data. By incorporating user information feature data, the machine learning model is provided with further information that helps the determination of the relationship between the appliance usage status and the electricity meter sequence data, thereby improving the accuracy of the second-type appliance status analysis model for low-correlation appliances.

By far, the first-type appliance status analysis model for high-correlation appliances and the second-type appliance status analysis model for low-correlation appliances have been completed.

In step S105, the processor 12 either inputs an unanalyzed electricity meter sequence data into the first-type appliance status analysis model, or inputs an unanalyzed electricity meter feature data and an unanalyzed user information feature data into the second-type appliance status analysis model, to generate at least one appliance status analysis result for at least one of the appliance types. For example, the appliance status analysis result may indicate, within the time duration of the unanalyzed electricity meter sequence data, whether the appliance 50 was in the on or off state during plurality of specified time periods.

The unanalyzed electricity meter sequence data comes from an electricity meter monitor device 20 of an electricity meter to be analyzed, while the unanalyzed electricity meter feature data is generated from the unanalyzed electricity meter sequence data through the feature extraction process. The unanalyzed user information feature data is the user information feature data for the user associated with the electricity meter to be analyzed.

When the usage states of various appliances of a user within a certain time period are to be analyzed with the unanalyzed electricity meter sequence data, one of the following steps is executed according to whether the appliance type corresponds to high-correlation or low-correlation appliances. If the appliance type is a high-correlation appliance, the unanalyzed electricity meter sequence data is input into the first-type appliance status analysis model corresponding to said appliance type; if the appliance type is a low-correlation appliance, then the unanalyzed electricity meter feature data and the corresponding unanalyzed user information feature data are input into the corresponding second-type appliance status analysis model corresponding to said appliance type. As a result, appliance status analysis results for different appliances are obtained.

For instance, the user possesses an air conditioner, refrigerator, television, and washing machine. Air conditioners and refrigerators are defined as high-correlation appliances, while televisions and washing machines are defined as low-correlation appliances. Therefore, the analysis models corresponding to the air conditioner and refrigerator are first-type appliance status analysis models, and the analysis models corresponding to the television and washing machine are second-type appliance status analysis models. Thus, when the processor 12 receives unanalyzed electricity meter sequence data, the processor 12 inputs the data directly into the air conditioner's first-type appliance status analysis model if the processor 12 needs to generate an appliance status analysis result for the air conditioner. On the other hand, the processor 12 first generates unanalyzed electricity meter feature data from the unanalyzed electricity meter sequence data, and then inputs this feature data and the unanalyzed user information feature data into the washing machine's second-type appliance status analysis model if the processor 12 needs to generate an appliance status analysis result for the washing machine.

Combining the appliance status analysis results generated by the first-type and second-type appliance status analysis models of different appliance types, a comprehensive analysis result is produced for the user's appliances over the time period of the unanalyzed electricity meter sequence data. The comprehensive analysis result reflects the usage state of plurality of appliances during that period.

In summary, the present disclosure successfully analyzes and produces the on/off usage information of electrical appliances, providing precise power consumption analysis for smart home energy management. The present disclosure can identify and detect the load conditions of various home appliances, offering customized home appliance scheduling strategies and energy management recommendations. Under low-sampling-rate situations, through proper selection and optimization strategies, such as using deep learning models with raw appliance usage status data and raw electricity meter data for high-correlation appliances, and combining feature extraction with machine learning models for low-correlation appliances, the accuracy of NILM at low sampling rate has been improved by at least 5%, achieving an excellent accuracy rate of 90%.

What is claimed is:

1. An electrical appliance status analysis device, electrically connected to an electricity meter, comprising:
a storage unit, configured to store a plurality of user information feature data, a plurality of electricity meter sequence data, and a plurality of appliance status sequence data, wherein each appliance status sequence data corresponds to a respective appliance type, and has the same time series as the corresponding electricity meter sequence data;
a processor, electrically connected to the storage unit, configured to read the plurality of user information feature data, the plurality of electricity meter sequence data, and the plurality of appliance status sequence data, and performing the following steps to the appliance status sequence data corresponding to the same appliance type:
defining said appliance type as a high-correlation appliance or a low-correlation appliance according to an average correlation coefficient of the plurality of appliance status sequence data and the corresponding electricity meter sequence data;
inputting the plurality of appliance status sequence data defined as high-correlation appliance and the corresponding electricity meter sequence data into a first-type model to perform model training, and generating a first-type appliance status analysis model for said appliance type;
performing a feature extraction process on the plurality of appliance status sequence data defined as low-correlation appliance and corresponding electricity meter sequence data, generating a plurality of appliance feature data and a plurality of electricity meter feature data, and inputting the plurality of appliance feature data, the plurality of electricity meter feature data and the plurality of user information feature data into a second-type model to perform model training, and generating a second-type appliance status analysis model for said appliance type; and
inputting an unanalyzed electricity meter sequence data into the first-type appliance status analysis model, or inputting an unanalyzed electricity meter feature data and an unanalyzed user information feature data into the second-type appliance status analysis model, and generating at least one appliance status analysis result corresponding to at least one of the appliance types.

2. The analysis device as claimed in claim 1, wherein plurality of data points in the appliance status sequence data each correspond to one of an on-state tag and an off-state tag.

3. The analysis device as claimed in claim 2, wherein the processor is further configured to execute a status tagging procedure, which includes dividing the time series of an appliance electricity usage original data by a tagging cycle, comparing a value of a plurality of data points in each tagging cycle to an activated load threshold value, and calculating a number of the data points in each tagging cycle that exceed the activated load threshold value;
if the number of data points that exceed the activated load threshold value within the tagging cycle is higher than a comparing number threshold value, determining the plurality of data points in the tagging cycle correspond to the on-state tag;
if the number of data points that exceed the activated load threshold value within the tagging cycle is lower than the comparing number threshold value, determining the plurality of data points in the tagging cycle correspond to the off-state tag.

4. The analysis device as claimed in claim 3, wherein a data frequency of the plurality of electricity meter sequence data and the plurality of appliance electricity usage original data is below 1 Hertz.

5. The analysis device as claimed in claim 1, wherein defining said appliance type as a high-correlation appliance or a low-correlation appliance according to an average correlation coefficient of the appliance status sequence data and the corresponding electricity meter sequence data further comprising:
calculating a Pearson correlation coefficient of each appliance status sequence data and the corresponding electricity meter sequence data, and calculating the average correlation coefficient of the Pearson correlation coefficients of the plurality of appliance status sequence data;
comparing the average correlation coefficient with a correlation threshold value;
if the average correlation coefficient is higher than the correlation threshold value, defining the appliance type corresponding to the plurality of appliance status sequences is defined as a high-correlation appliance;
if the average correlation coefficient is lower than the correlation threshold value, defining the appliance type corresponding to the plurality of appliance status sequences is defined as a low-correlation appliance.

6. The analysis device as claimed in claim 1, wherein the second-type model is different from the first-type model; the first-type model is a neural network deep learning model, and the second-type model is a machine learning model.

7. The analysis device as claimed in claim 1, wherein the user information feature data includes at least one of the following or a combination thereof: user routine survey information, user appliance usage habit survey information, user household member survey information, and user electricity meter load classification label information.

8. An electrical appliance status analysis method, executed based on plurality of user information feature data, plurality of electricity meter sequence data, and plurality of appliance status sequence data, wherein each appliance status sequence data corresponds to a respective appliance type, and has the same time series as the corresponding electricity meter sequence data; the method comprising:
reading the plurality of user information feature data, the plurality of electricity meter sequence data, and the plurality of appliance status sequence data, and performing the following steps to the appliance status sequence data corresponding to the same appliance type:
defining said appliance type as a high-correlation appliance or a low-correlation appliance according to an average correlation coefficient of the plurality of appliance status sequence data and corresponding electricity meter sequence data;
inputting the plurality of appliance status sequence data defined as high-correlation appliances and corresponding electricity meter sequence data into a first-type model to perform model training, and generating a first-type appliance status analysis model for said appliance type;
performing a feature extraction process on the plurality of appliance status sequence data defined as low-correlation appliances and corresponding electricity meter sequence data, generating a plurality of appliance feature data and a plurality of electricity meter feature data, and inputting the plurality of appliance feature data, the plurality of the electricity meter feature data, and the plurality of user information feature data into a second-type model to perform model training, and generating a second-type appliance status analysis model for said appliance type; and
inputting unanalyzed electricity meter sequence data into the first-type appliance status analysis model, or inputting the unanalyzed electricity meter feature data and an unanalyzed user information feature data into the second-type appliance status analysis model, and generating at least one appliance status analysis result corresponding to at least one of the appliance types.

9. The analysis method as claimed in claim 8, wherein plurality of data points in the appliance status sequence data each correspond to one of an on-state tag and an off-state tag.

10. The analysis method as claimed in claim 9, wherein the processor is further configured to execute a status tagging procedure, which includes dividing a time series of an appliance electricity usage original data by a tagging cycle, comparing a value of plurality of data points in each tagging cycle to an activated load threshold value, and calculating a number of the data points in each tagging cycle that are larger than the activated load threshold value;
if the number of data points that exceed the activated load threshold value within the tagging cycle is higher than a comparing number threshold value, determining the plurality of data points in the tagging cycle correspond to the on-state tag:
if the number of data points that exceed the activated load threshold value within the tagging cycle is not lower than the comparing number threshold value, determining the plurality of data points in the tagging cycle correspond to the off-state tag.

11. The analysis method as claimed in claim 10, wherein a data frequency of the plurality of electricity meter sequence data and the plurality of appliance electricity usage original data is below 1 Hertz.

12. The analysis method as claimed in claim 8, wherein defining said appliance type as a high-correlation appliance or a low-correlation appliance according to an average correlation coefficient of the appliance status sequence data and the corresponding electricity meter sequence data further comprising:
calculating a Pearson correlation coefficient of each appliance status sequence data and the corresponding electricity meter sequence data, and calculating the average correlation coefficient of the Pearson correlation coefficients of the plurality of appliance status sequence data;
comparing the average correlation coefficient with a correlation threshold value;
if the average correlation coefficient is higher than the correlation threshold value, defining the appliance type corresponding to the plurality of appliance status sequence data is defined as a high-correlation appliance;
if the average correlation coefficient is lower than the correlation threshold value, defining the appliance type corresponding to the plurality of appliance status sequence data is defined as a low-correlation appliance.

13. The analysis method as claimed in claim 8, wherein the second-type model is different from the first-type model; the first-type model is a neural network deep learning model, and the second-type model is a machine learning model.

14. The analysis method as claimed in claim 8, wherein the user information feature data includes at least one of the following or a combination thereof: user routine survey information, user appliance usage habit survey information, user household member survey information, and user electricity meter load classification label information.
